(19) United States
(12) Patent Application Publication
(10) Pub. No.: US 2003/0016749 A1
(43) Pub. Date: Jan. 23, 2003

(54) Image-decoding method and device thereof

(75) Inventor: Chi-Hui Wang, Hsinchu (TW)

Correspondence Address: Haverstock & Owens LLP, Suite 420, 260 Sheridan Avenue, Palo Alto, CA, 94306, US

(73) Assignee: Winbond Electronics Corp

(21) Appl. No.: 10/191,883

(22) Filed: Jul. 8, 2002

(30) Foreign Application Priority Data
Jul. 18, 2001 (CN) 090117597

(51) Int. Cl. H04N 7/12

(52) U.S. Cl. 375/240.15; 375/240.25; 375/240.12; 348/96; 348/97

(57) ABSTRACT

The present invention relates to an image-decoding method and device thereof. The image-decoding device includes a memory, a modifying means, a decoding unit, an image reconstruction unit and a display controller. The image-decoding device includes the steps of capturing the B-frame data and the reference frame data form plural digital image data in the memory, decoding a first field data for obtaining a decoded first field data, and decoding a second field data by means of referring the decoded first field data and the reference frame data for obtaining a decoded second field data overwriting the decoded first field data.

### FIELD OF THE INVENTION

The present invention is related to an image-decoding method and device thereof and more particularly, to an image-decoding method and device thereof applied to the Motion Picture Experts Group (MPEG).

### BACKGROUND OF THE INVENTION

Generally, when analog signals of an image are transformed to digital signals for a display system, the digital signals have to fit in with the specifications and the display area of the display system.

Now, the form of a digital image in video signals is defined by the motion picture experts group (MPEG). The specifications of the display system for a digital versatile disk (DVD) and a high definition television (HDTV) both are defined via a new standard of MPEG2. FIG. 1 illustrates a typical image data stream of MPEG 2. The typical image data stream of MPEG 2 includes three kinds of pictures. (1) Intra-coded picture (I-picture) is an anchor frame and being encoded merely according to one picture data but without referring another picture. (2) Predictive-coded picture (P-picture) is also regarded as an anchor frame and being encoded by means of the motion compensation. Meanwhile, the P-picture is encoded via evaluating the motion of a previous P-picture/I-picture, so as to encode the change part of the P-picture merely. (3) Bidirectionally predictive-coded picture (B-picture) is encoded by means of the motion compensation in response to referring the motion of a previous/following P-picture/I-picture. Meanwhile, the B-picture has to be encoded via analyzing another previous/following P-picture/I-picture. The above I-picture, P-picture and B-picture are called as the I-frame, P-frame and B-frame respectively.

All of those picture can be divided into 8×8 pixel blocks, and six 8×8 pixel blocks compose a macro block (MB). The image data stream including image data is encoded according to the raster scan order of the macro blocks.

Generally, a MPEG decoding device loads the image data stream first and then executes the decoding procedure. FIG. 2 illustrates a decoding process according to the prior art. The decoding procedure of the prior art includes the steps of (a) loading an image data stream, (b) executing a variable length decoding process 21, (c) executing a de-quantization (DEQ) process 22, and (d) executing an inverse discrete cosine transformation process 23. The decoding procedure of the prior art further includes a step of (e) executing a motion compensation process for the P-picture and B-picture after the step of (d) executing an inverse discrete cosine transformation process 23, so as to compensate the image data of the previous P-picture/I-picture inputted into the frame buffer 25. Hence, the decoding picture is displayed after the process of the motion compensation is finished. Accordingly, when all of I-pictures, P-pictures and B-picture in an image data stream are decoded, the decoded I-pictures/P-pictures have to be stored into a frame buffer 25 of a memory for providing encoded P-pictures or B-pictures for reference, so as to execute a decoding procedure effectively. Moreover, the decoded B-pictures also have to be stored into the frame buffer 25 for being displayed efficiently. The above decoding procedure is executed in a basic unit and a micro block.

Main cost is usually increased by the memory of the MPEG decoding device, and more particularly by the memory of the MPEG decoding device disposed on one chip in the current trend of system on chip (SOC). FIG. 3 illustrates the contents of a memory of a MPEG decoding device. The memory 30 includes an I-frame buffer 31 in response to the decoded I-pictures, a P-frame buffer 32 in response to the decoded P-pictures, a B-frame buffer 33 in response to the decoded B-pictures, an Audio bitstream buffer 34 for storing the audio bitstream therein, and a video bitstream buffer 35 for storing the video bitstream, so as to display the audio and those pictures simultaneously and smoothly. Meanwhile, I-pictures, P-pictures and B-pictures are stored in the memory of the MPEG decoding device according to the sorting order for display. It further includes some non-frame data buffer 36 for executing instant display on a DVD monitor, searching and providing a vocal accompaniment. The non-frame data buffer 36 is disposed on the same memory simultaneously, so as to include all specifications of the above functions in the decoding device.

In FIG. 3, all frame data buffers occupy the greater part of the memory spaces, but the non-frame data buffer occupies a few memory spaces. In the era of SOC, non-buffer memory space increase significantly these years because of various new system applications. If all frame data buffers and the non-frame buffer are set into same memory, user has to allocate the memory buffer very carefully to prevent from running out the available memory space and forced to add the extra memory that increase the overall system cost finally.

It is a difficult problem for an image-decoding researcher to solve the shortage of the memory spaces. In the prior art, some people solve problem by adding additional pixel data encoding/decoding mechanism on the interface of memory to reduce the occupied spaces of all frame data buffers. For example, some researchers implement a lossless compression process via a complex data code for storing the decoded I-pictures, the decoded P-pictures and the decoded I-pictures into the memory, so as to reduce the occupied memory spaces. The method keeps the quality of the motion pictures, however, it costs a lot because of implementation of complex mathematical logical circuit. On the other hand, some researchers implement a lossy compression/decompression mechanism via a simpler H/W circuit. It reduces overall design complexity as well as the occupied memory space. However, this approach usually reduces the quality of the motion pictures at the same time.

Therefore, it is tried to rectify this drawback by the present applicant. The present invention provides an image-decoding method and device thereof for solving the shortage of the memory spaces in a MPEG device.

### SUMMARY OF THE INVENTION

It is therefore an objective of the present invention to provide an image-decoding method and device thereof for solving the shortage of the memory spaces in a MPEG device. According to the present invention, the image-decoding method includes the steps of capturing a bidirectionally predictive-coded frame (B-frame) data and a reference frame data corresponding to the B-frame data from the plural digital image data in the memory, decoding a first field data of the B-frame data by means of referring the reference frame data for obtaining a decoded first field data, and decoding a second field data of the B-frame data by means of referring the decoded first field data and the reference frame data for obtaining a decoded second field data overwriting the decoded first field data.

Certainly, the plural digital image data can be motion picture expert group (MPEG) data.

Certainly, the plural digital image data can include intra-coded frames (I-frames), predictive-coded frames (P-frames) and bidirectionally predictive-coded frames (B-frames).

Certainly, the first field data and the second field data can be selected respectively from a top field data and a bottom field data of the B-frame data.

Certainly, the reference frame data can be a frame pixel data.

Preferably, the image-decoding method further includes a step of modifying the reference frame data, so as to provide the reference frame data for the B-frame data correctly before referred.

Certainly, the first field data can be stored in the memory and occupy a memory space being one half of that of the reference frame.

Certainly, the second field data can be stored in the memory and occupy a memory space being one half of that of the reference frame.

Certainly, the plural digital image data can be a 3:2 pull down picture.

Preferably, the B-frame data include the first field data, the second field data and a third field data formed by means of decoding the first field data.

Certainly, the second field data can be registered in the memory for being further accessible thereto.

Preferably, the second field data is stored in the memory and occupies a memory space being one half of that of the reference frame.

Preferably, the image-decoding method further includes a step of decoding the first field data for obtaining the third field data corresponding to the first field data after loading the second field data and the reference frame data, so as to register the third field data in the memory.

Preferably, the third field data is stored in the memory and occupies a memory space being one half of that of the reference frame.

Preferably, the reference frame data is selected from one of a decoded I-frame and a decoded P-frame.

Preferably, the I-frame and P-frame are an I frame pixel data and a P frame pixel data respectively.

Certainly, the B-frame data can be selected from one of a 16×8 picture block and a 16×16 picture block.

Certainly, the reference frame data can be selected from one of a 16×8 picture block and a 16×16 picture block.

According to the present invention, the image-decoding device for decoding plural digital image data in a memory includes a bidirectionally predictive-coded frame (B-frame) data having a first field data and a second field data, a reference frame data corresponding to the B-frame data and selected from the plural digital image data in the memory, a modifying means for modifying the reference frame data, so as to provide the reference frame data for the B-frame data correctly, a decoding unit for decoding the B-frame data by means of referring the modified reference frame data, so as to obtain a decoded first field data, an image reconstruction unit for reconstructing the reference frame data and the decoded first field data, and a display controller for controlling and being accessible to the decoded first field data and the reference frame data, thereby the image-decoding device further decoding the second field data by means of referring the decoded first frame data and the reference frame data.

Certainly, the plural digital image data, the decoded first field data and the reference frame data can be stored in the memory.

Certainly, the first field data and the second field data can be selected from a top field data and a bottom field data of the B-frame data respectively.

Certainly, the reference frame data can be a frame pixel data.

Preferably, the first field data is stored in the memory and occupies a memory space being one half of that of the reference frame.

Preferably, the second field data is stored in the memory and occupies a memory space being one half of that of the reference frame.

Preferably, the image-decoding device decodes the second field data of the B-frame data for obtaining a decoded second field data.

Certainly, plural digital picture data can be a 3:2 pull down picture.

Certainly, the 3:2 pull down picture can be the B-frame data comprising the first field data, the second field data and a third field data formed by means of decoding the first field data.

Preferably, the image-decoding device decodes the second field data for obtaining a decoded second field data corresponding to the second field data.

Preferably, the second field data is stored in the memory and occupies a memory space the same as that of the first field data and being one half of that of the reference frame.

Preferably, the first field data is decoded after being accessible to the second field data and the reference frame data for obtaining the third field data corresponding to the first field data, so as to register the third field data in the memory for being further accessible thereto.

Preferably, the third field data is stored in the memory and occupies a memory space the same as that of the first field data and being one half of that of the reference frame.

Preferably, the reference frame data is selected from one of an I frame pixel data and a P frame pixel data.

According to the present invention, the image-decoding method for decoding plural digital image data in a memory includes steps of providing a bidirectionally predictive-coded frame (B-frame) data and capturing a reference frame data corresponding to the B-frame data from the plural digital image data in the memory, wherein the B-frame data includes a first field data, modifying the reference frame data to be provided for the B-frame data correctly, decoding the first field data by means of referring the reference frame data for obtaining a decoded first field data, reconstructing the decoded first field data and the reference frame data, so as to register and be accessible to the decoded first field data and the reference frame data in the memory for being further accessible to decode the B-frame data.

The foregoing and other features and advantages of the present invention will be more clearly understood through the following descriptions with reference to the drawings, wherein:

### BRIEF DESCRIPTION OF THE DRAWING

FIG. 1 illustrates a typical image data stream of MPEG 2;

FIG. 2 illustrates a conventional decoding method according to the prior art;

FIG. 3 illustrates the storage structure in a memory of a conventional decoding device;

FIG. 4 illustrates an image-decoding method according to the present invention;

FIG. 5 illustrates how the image-decoding method of the present invention processes the field data; and

FIG. 6 illustrates the storage structure in a memory of a decoding device of the present invention.

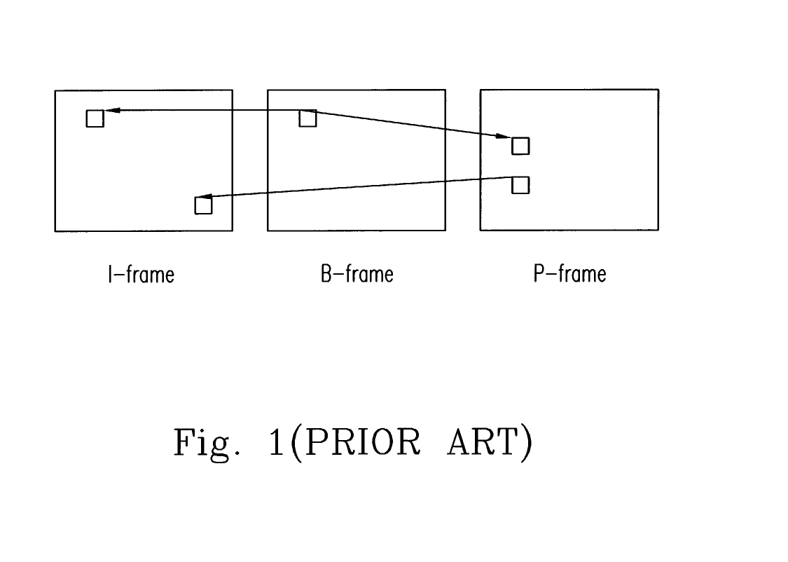

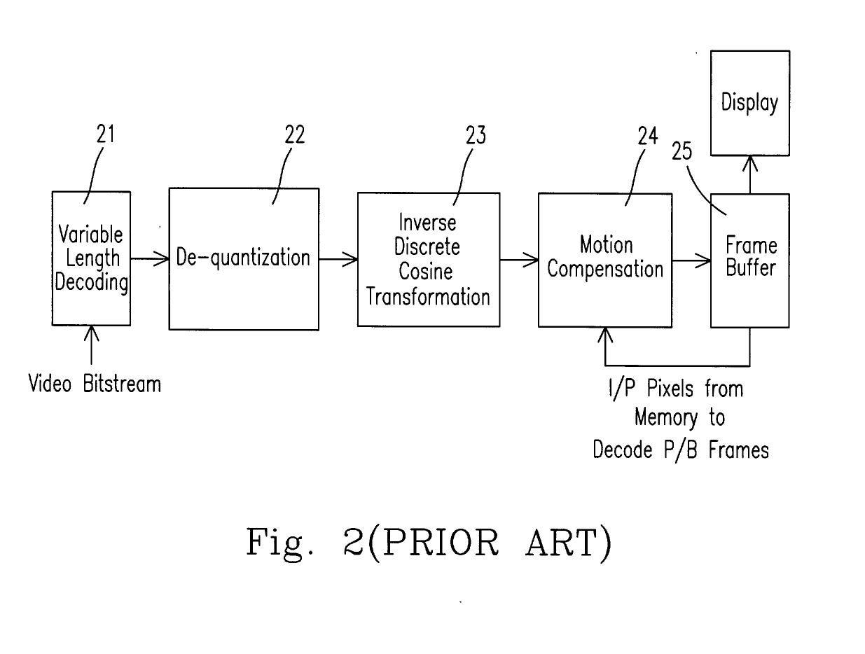

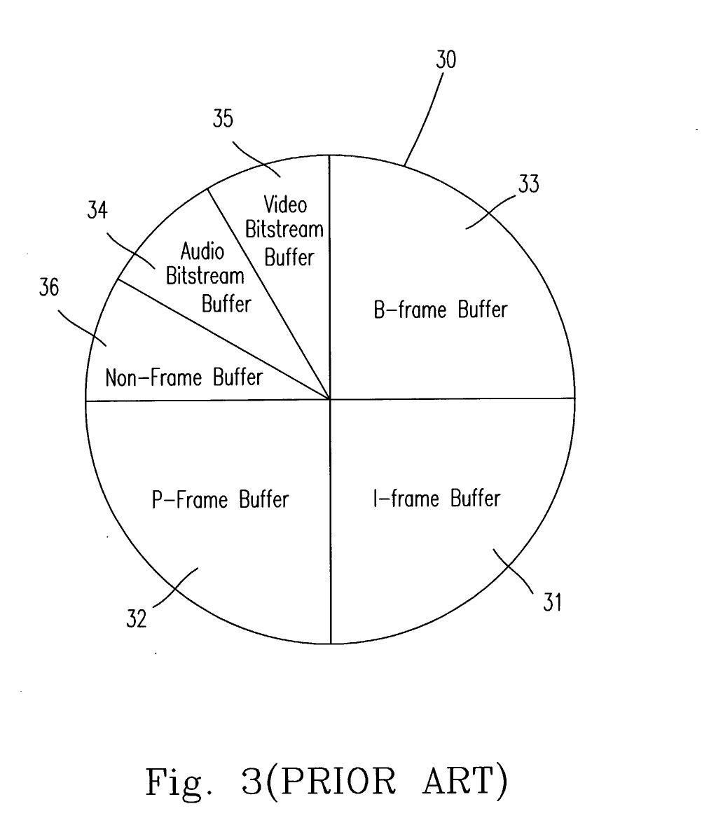

### DETAILED DESCRIPTION OF THE PREFERRED EMBODIMENTS

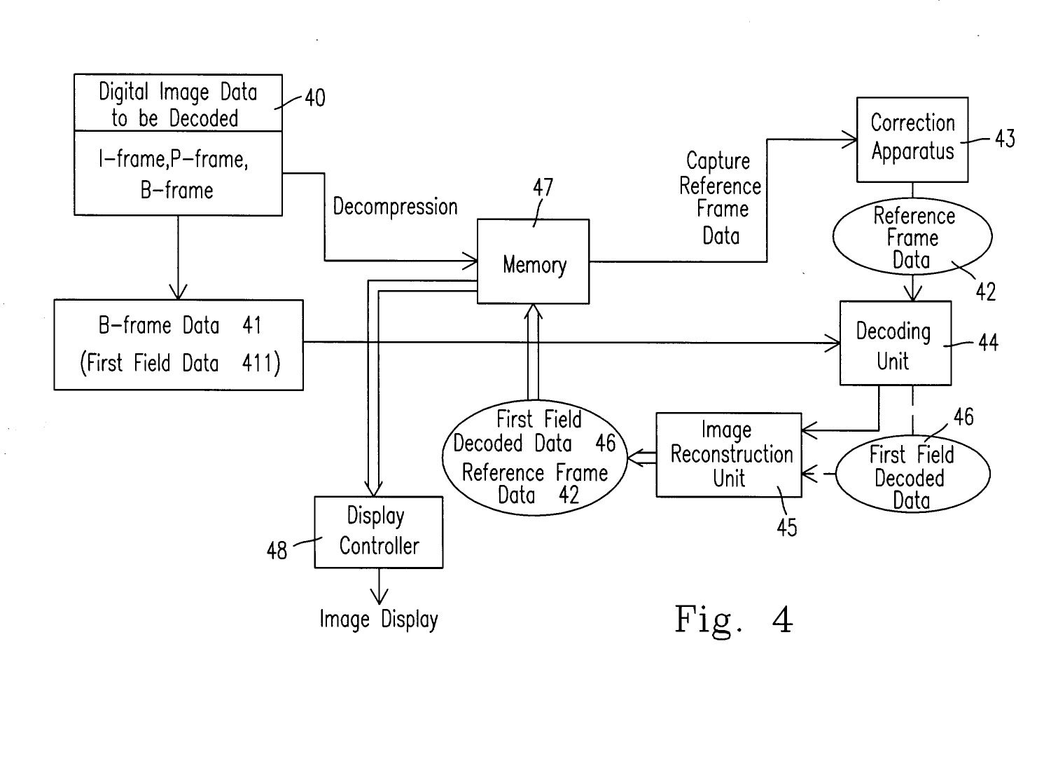

Please refer to FIG. 4. It illustrates an image-decoding method according to the present invention. The image-decoding method for decoding plural digital image data in a memory includes the following steps. Firstly, a bidirectionally predictive-coded frame (B-frame) data 41 and a reference frame data 42 corresponding to the B-frame data 41 are captured from the plural digital image data 40 in the memory 47, wherein the B-frame includes a first field data 411. Secondly, the first field data 411 of the B-frame data 41 is decoded by means of referring the reference frame data 42 for obtaining a decoded first field data 46. Thirdly, the decoded first field data 46 and the reference frame data 42 are reconstructed, so as to register and be accessible to the decoded first field data 46 and the reference frame data 42 in the memory 47 for being further accessible to decode the B-frame data 41. Finally, the first field data 46 and the reference frame data 42 are loaded from the memory 47 for decoding the plural digital image data 40 in succession until all B-frame data 41 of the plural digital image data 40 are decoded.

In FIG. 4, the image-decoding device of the present invention includes a modifying means 43 for modifying the reference frame data 42, so as to provide the reference frame data 42 for the B-frame data 41 correctly, a decoding unit 44 for decoding the first field data 411 of the B-frame data 41 by means of referring the modified reference frame data 42, so as to obtain a decoded first field data 46, an image reconstruction unit 45 for reconstructing the reference frame data 42 and the decoded first field data 46, a memory 47 for storing the plural digital image data 40, the decoded first field data 46 and the reference frame data 42, and a display controller 48 for controlling and being accessible to the decoded first field data 46 and the reference frame data 42, thereby the image-decoding device can display the pictures.

The image-decoding method and the device thereof have a lot of characteristics as followings. (1) When the plural digital image data 40 including encoded I-frames, encoded P-frames and encoded B-frames are loaded into to the image-decoding device, the image-decoding device of the present invention will decode the encoded I-frames and the encoded P-frames by means of executing a decoding process and store the decoded I-frames and the decoded P-frames into the memory 47. However, the B-frames are decoded while the pictures are displayed. Before displaying a B-frame, the image-decoding device of the present invention decodes the B-frame first and then captures the I-frame and P-frame corresponding to the B-frame from the memory 47, so as to execute the above decoding process. (2) The image-decoding device of the present invention, which is unlike the conventional decoding device, provides a modifying means for modifying the reference frame data, so as to provide the reference frame data for the B-frame data correctly. (3) The image-decoding device of the present invention merely decodes one field data every time. According to the above embodiment, the decoded second field data overwrites the decoded first field data in the memory for recoding single field data in the memory. Therefore, the image-decoding device occupies less memory spaces. Comparing with the conventional image-decoding device, the decoded B-frame data generated by the present invention occupies a memory space being one half of that of the conventional image-decoding device. The following embodiments can also demonstrate the above characteristics of the present invention.

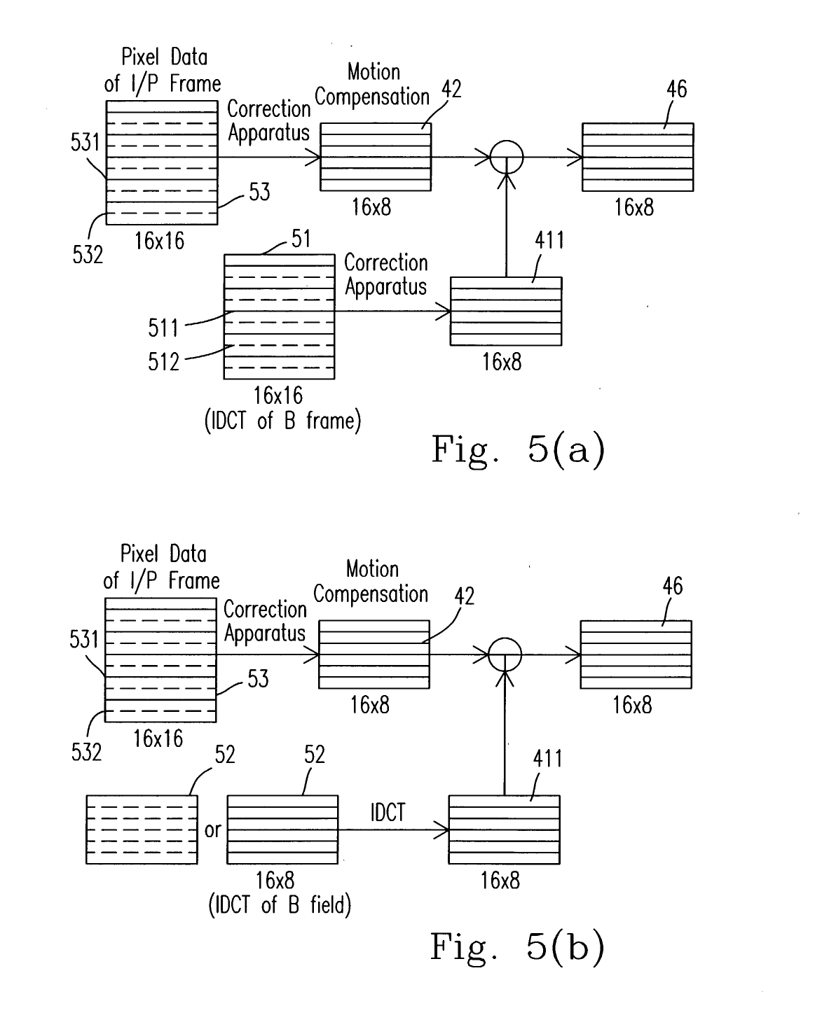

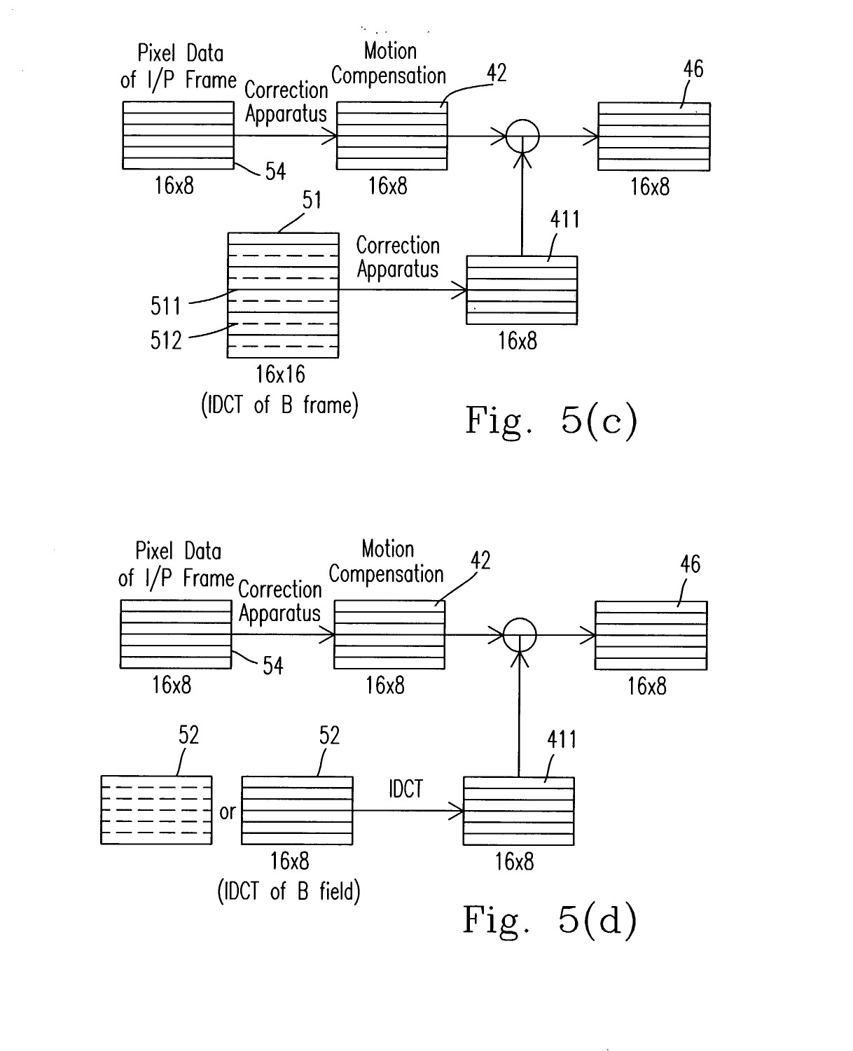

Please refer to FIGS. 4 and 5. FIG. 5 illustrates how the image-decoding method of the present invention processes the field data. As shown in FIGS. 5(a) and 5(b), the B-frame data 41 is composed of the frame pixel data. Certainly, the frame pixel data can be 16×16 picture blocks 51. Certainly, the B-frame data 41 can be selected from 16×8 picture blocks 52 for being decoded, which is shown as FIGS. 5(b) and 5(d). Meanwhile, the picture block can be composed of a top field data 511 and a bottom field data 512. Certainly, the picture block 52 can be composed of a single field shown in FIGS. 5(b) and 5(d).

Furthermore, in FIGS. 5(a) and 5(b), the I-frame data and P-frame data of the plural digital image data 40 are composed of 16×16 picture blocks 53. In FIGS. 5(c) and 5(d), the I-frame data and P-frame data of the plural digital image data 40 are composed of 16×8 picture blocks 54. Meanwhile, the 16×16 picture blocks 53 in FIGS. 5(a) and 5(b) are composed of a top field data 531 and a bottom field data 532. In FIGS. 5(c) and 5(d), the 16×8 picture blocks 54 is composed of a single field.

According to the present invention, the B-frame data is decoded while it is going to be displayed. No matter the B-frame data includes single field data or two field data, the image-decoding device of the present invention merely decodes single field data and stores it into the memory. FIGS. 5(a)-5(d) illustrate several different decoding method. Those different decoding methods are provided in response to the types of the pictures, the forecasted pictures, and the demand of the inverse discrete cosine transformation process and the motion compensation process during decoding.

Please refer to FIGS. 4 and 5. FIGS. 5(a) and 5(c) show a B-frame data as a frame picture having executed the motion compensation process in the top field data 511 and the bottom field data 512. One of the top field data 511 and the bottom field data 512 is captured as the first field data 411 after executing the inverse discrete cosine transformation process. The reference frame data 42 is further captured corresponding to the top field data 511 or the bottom field data 512 of the B-frame data 41 from the plural digital image data 40 stored in the memory 47, and is modified via the modifying means 43 for being referred during decoding the B-frame data 41. Meanwhile, the reference frame data 42 has been decoded and stored in the I-frame or P-frame in the memory 47. Then the decoding unit 44 executes the motion compensation process by means of referring the modified reference frame data 42, which is the top field data 511 or the bottom field data 512 of I-frame/P-frame data and decodes the first field data 411 of the B-frame data 41, so as to obtain a decoded first field data 46 occupying a memory space being one half of that of the reference frame 42. Next, the reference frame data 42 and the decoded first field data 46 are reconstructed via the image reconstruction unit 45 and stored in the memory 47. Finally, the decoded first field data 46 is loaded and displayed via the display controller 48. Certainly, the remained one of the top field data 511 and the bottom field data 512 can be the second field data. The second field data is decoded via repeating the above decoding procedure after the first field data 46 and the reference frame data 42 are loaded from the memory 47 and displayed. The decoding procedure is executed in succession until all B-frame data 41 of the plural digital image data 40 are decoded and displayed.

FIGS. 5(b) and 5(d) show a B-frame data including the single field data. A complete frame is composed of two B fields, and the motion compensation process is executed merely for the single field data. Accordingly, the I-frame data, the P-frame data and the B-frame data respectively including top field data 511 and the bottom field data 512 have to be decoded by means of executing twice the decoding procedure, but the decoded first field data 46 or the decoded second field data stored into the memory 47 in each decoding procedure is the 16×8 picture block data, thereby the decoded first field data occupies a memory space being one half of that of the prior art. Furthermore, in FIGS. 5(b) and 5(d), only one field data is decoded in each decoding procedure and the decoded first field data occupying a memory space being one half of that of the prior art is also the 16×8 picture block data. The B-frame data including two field data have to be decoded twice. Meanwhile, the first field data is obtained in first time and the second field data is obtain in second time.

Moreover, the image-decoding method and the image-decoding method can be applied to the MPEG-2 movies or pictures, which is displayed via 3:2 pull down pictures. The 3:2 pull down picture is the B-frame data including the first field data, the second field data and a third field data formed by means of decoding the first field data. When the B-frame data including three field data is decoded according to the present invention, firstly, the second field data is decoded by means of referring the decoded first field data and the reference frame data. Secondly, the decoded second field data corresponding to the second field data is obtained via the decoding unit 44 and registered in the memory for being further accessible thereto. Finally, the first field data is re-decoded after being accessible to the second field data and the reference frame data for obtaining the third field data corresponding to the first field data, so as to register the third field data in the memory for being further accessible thereto. The decoding procedure is executed in succession until all B-frame data of the plural digital image data are decoded.

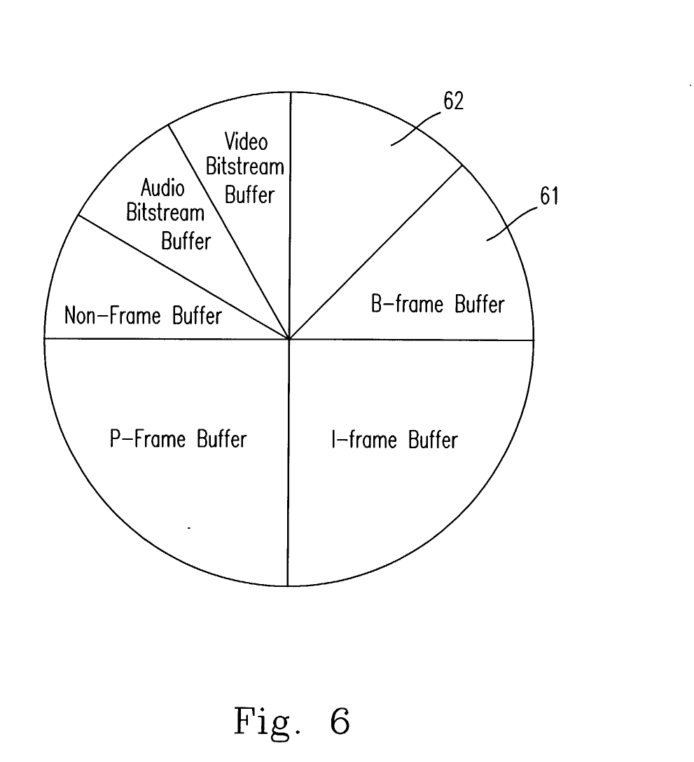

Please refer to FIG. 6. The decoded field data (the decoded first field data, the decoded second field data or the decoded third field data) is stored in the memory and occupies a memory space 61 being one half of that of the prior art. The present invention provides the image-decoding method and the image-decoding device reducing the demand of the memory spaces and saving more memory spaces 62 by means of modifying the procedure of the inverse discrete cosine transformation process and the motion compensation process, and executing the decoding procedure twice or three times. The method keeps 100% the quality of the pictures and reduces the demand of the memory spaces effectively.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image-decoding method for decoding plural digital image data in a memory comprising steps of:
capturing a bidirectionally predictive-coded frame (B-frame) data and a reference frame data corresponding to said B-frame data from said plural digital image data in said memory;
decoding a first field data of said B-frame data by means of referring said reference frame data for obtaining a decoded first field data; and
decoding a second field data of said B-frame data by means of referring said decoded first field data and said reference frame data for obtaining a decoded second field data overwriting said decoded first field data.

2. The image-decoding method according to claim 1 wherein said plural digital image data are motion picture expert group (MPEG) data.

3. The image-decoding method according to claim 1 wherein said plural digital image data comprise intra-coded frames (I-frames), predictive-coded frames (P-frames) and bidirectionally predictive-coded frames (B-frames).

4. The image-decoding method according to claim 1 wherein said first field data and said second field data are selected respectively from a top field data and a bottom field data of said B-frame data.

5. The image-decoding method according to claim 1 wherein said reference frame data is a frame pixel data.

6 The image-decoding method according to claim 1 further comprising a step of modifying said reference frame data, so as to provide said reference frame data for said B-frame data correctly before referred.

7. The image-decoding method according to claim 1 wherein said first field data is stored in said memory and occupies a memory space being one half of that of said reference frame.

8. The image-decoding method according to claim 1 wherein said second field data is stored in said memory and occupies a memory space being one half of that of said reference frame.

9. The image-decoding method according to claim 1 wherein said plural digital image data are a 3:2 pull down pictures.

10. The image-decoding method according to claim 9 wherein said B-frame data comprise said first field data, said second field data and a third field data formed by means of decoding said first field data.

11. The image-decoding method according to claim 10 wherein said second field data is registered in said memory for being further accessible thereto.

12. The image-decoding method according to claim 11 wherein said second field data is stored in said memory and occupies a memory space being one half of that of said reference frame.

13. The image-decoding method according to claim 12 further comprising a step of decoding said first field data for obtaining said third field data corresponding to said first field data after loading said second field data and said reference frame data, so as to register said third field data in said memory.

14. The image-decoding method according to claim 13 wherein said third field data is stored in said memory and occupies a memory space being one half of that of said reference frame.

15. The image-decoding method according to claim 14 wherein said reference frame data is selected from one of a decoded I-frame and a decoded P-frame.

16. The image-decoding method according to claim 14 wherein said I-frame and P-frame are an I frame pixel data and a P frame pixel data respectively.

17. The image-decoding method according to claim 1 wherein said B-frame data is selected from one of a 16×8 picture block and a 16×16 picture block.

18. The image-decoding method according to claim 1 wherein said reference frame data is selected from one of a 16×8 picture block and a 16×16 picture block.

19. An image-decoding device for decoding plural digital image data in a memory comprising:
a bidirectionally predictive-coded frame (B-frame) data having a first field data and a second field data;
a reference frame data corresponding to said B-frame data and selected from said plural digital image data in said memory;
a modifying means for modifying said reference frame data, so as to provide said reference frame data for said B-frame data correctly;
a decoding unit for decoding said B-frame data by means of referring said modified reference frame data, so as to obtain a decoded first field data;
an image reconstruction unit for reconstructing said reference frame data and said decoded first field data; and
a display controller for controlling and being accessible to said decoded first field data and said reference frame data, thereby said image-decoding device further decoding said second field data by means of referring said decoded first frame data and said reference frame data.

20. The image-decoding device according to claim 19 wherein said plural digital image data, said first field data and said reference frame data are stored in said memory.

21. The image-decoding device according to claim 19 wherein said first field data and said second field data are selected from a top field data and a bottom field data of said B-frame data respectively.

22. The image-decoding device according to claim 19 wherein said reference frame data is a frame pixel data.

23 The image-decoding device according to claim 19 wherein said first field data is stored in said memory and occupies a memory space being one half of that of said reference frame.

24. The image-decoding device according to claim 19 wherein said second field data is stored in said memory and occupies a memory space being one half of that of said reference frame.

25. The image-decoding device according to claim 19 wherein said image-decoding device decodes said second field data of said B-frame data for obtaining a decoded second field data.

26. The image-decoding device according to claim 19 wherein said plural digital picture data are a 3:2 pull down pictures.

27. The image-decoding method according to claim 26 wherein said 3:2 pull down picture is said B-frame data comprising said first field data, said second field data and a third field data formed by means of decoding said first field data.

28. The image-decoding device according to claim 27 wherein said image-decoding device decodes said second field data for obtaining a decoded second field data corresponding to said second field data.

29. The image-decoding device according to claim 28 wherein said second field data is stored in said memory and occupies a memory space the same as that of said first field data and being one half of that of said reference frame.

30. The image-decoding device according to claim 28 wherein said first field data is decoded after being accessible to said second field data and said reference frame data for obtaining said third field data corresponding to said first field data, so as to register said third field data in said memory for being further accessible thereto.

31. The image-decoding device according to claim 30 wherein said third field data is stored in said memory and occupies a memory space the same as that of said first field data and being one half of that of said reference frame.

32. The image-decoding device according to claim 19 wherein said reference frame data is selected from one of an I frame pixel data and a P frame pixel data.

33. An image-decoding method for decoding plural digital image data in a memory comprising steps of:
providing a bidirectionally predictive-coded frame (B-frame) data and capturing a reference frame data corresponding to said B-frame data from said plural digital image data in said memory, wherein said B-frame data includes a first field data;
modifying said reference frame data to be provided for said B-frame data correctly;
decoding said first field data by means of referring said reference frame data for obtaining a decoded first field data;
reconstructing said decoded first field data and said reference frame data, so as to register and be accessible to said decoded first field data and said reference frame data in said memory for being further accessible to decode said B-frame data.
